(19) United States
(12) Patent Application Publication
(10) Pub. No.: US 2026/0208567 A1
(43) Pub. Date: Jul. 23, 2026

(54) PROTECTION METHOD FOR PROTECTING THE CURTAIN OF A ROLLER BLIND DEVICE FOR A REAR WINDOW BLIND ON A TAILGATE OF A VEHICLE

(71) Applicant: HS Products Engineering GmbH, Maisch (DE)

(72) Inventors: Martin Specht, Feldafing (DE); Mario Severn, Windach (DE); Niklas Christopher Gröver, München (DE); Alexander Jahraus, Emmering (DE)

(21) Appl. No.: 19/455,670

(22) Filed: Jan. 21, 2026

(30) Foreign Application Priority Data
Jan. 23, 2025 (DE) 10 2025 102 436.7

(51) Int. Cl. B60J 1/20

(52) U.S. Cl. CPC B60J 1/2016; B60J 1/2019; B60J 1/208

(57) ABSTRACT

A protective method for protecting a blind of a roller blind device for a rear roller blind on a tailgate of a vehicle which can be moved by means of an electric drive device between a retracted position (FP) and a covering position (AP) and, in the covering position (AP), at least partially covers a rear window of the tailgate against damage caused by luggage (L) in the boot, includes: detecting a movement of the tailgate of the vehicle, moving the blind of the roller blind device in the direction of the retracted position (FP) into a protected position (SP) when the movement of the tailgate has been detected, and holding the blind of the roller blind device in the protected position (SP) during at least part of a subsequent movement of the tailgate.

### CROSS-REFERENCE TO RELATED APPLICATIONS

This application claims the benefit of and priority to German Patent Application No. 102025102436.7, filed January 23, 2025, which is hereby incorporated by reference herein in its entirety.

### FIELD OF THE INVENTION

The present invention relates to a protective method for protecting a roller blind device for a rear roller blind on a tailgate of a vehicle, and a computer program product and a protective device for carrying out such a protective method.

### BACKGROUND OF THE INVENTION

It is known for roller blind devices to be used to cover window panes in vehicles to block a view of the interior. In the past, roller blind devices for the rear side windows have in particular been known which are able to obscure the view into the interior to such an extent that it is not possible to tell who is sitting in the rear seat. It is also known to provide a rear blind for the rear window on fixed rear windows, in so-called notchback saloons. Modern vehicles, especially station wagons or SUVs, are equipped with tailgates, which include not only part of the body but also the rear window. Such tailgates can be moved, together with the rear window, between a closed position and an open position to ensure access to the boot of the vehicle in the open position. In contrast to known rear roller blinds for fixed rear windows, rear roller blinds for such tailgates involve additional complexity, since they are arranged in a moving component, namely the swivelling tailgate.

While roller blind devices for rear windows in tailgates are also known in principle, there is a decisive problem with such devices. If the blind of the roller blind device is in a covering position, i.e. in an extended state, and the tailgate is opened, access is provided to the boot. When open, it is therefore possible to load luggage into the boot and then close the tailgate again. This can lead to geometric conflict situations in which, while the tailgate can be brought into the closed position, a geometric conflict arises between an edge of the loaded luggage and the blind. This means that when the tailgate is closed, the extended blind, in the covering position, is now pressed against the luggage and can potentially be damaged in this way. At the latest when this contact exists between an edge of an item of luggage and the blind in the covering position and the blind is now to be moved to a different position, this inevitably leads to damage to the blind as it is drawn over this edge by the force of a drive device. This is a major disadvantage since, when the tailgate is used as intended, this risk cannot be detected and prevented by the user of the vehicle, or only if paying close attention. Disadvantageously, this is made even more difficult by the fact that modern vehicles are now equipped with display devices for the rear rows of seats, the operational safety of which absolutely requires a functional covering position for the blind of the roller blind device.

A need therefore exists to remedy, at least in part, the disadvantages described above. In particular, a need exists for a protective method, and a computer program product and a device for carrying out such a protective method to protect the blind of a roller blind device against damage caused by bulky luggage in a cost-effective and simple manner with a high degree of reliability.

### SUMMARY OF THE INVENTION

According to certain aspects of the present disclosure, a protective method for protecting a blind of a roller blind device for a rear roller blind on a tailgate of a vehicle which can be moved by means of an electric drive device between a retracted position (FP) and a covering position (AP) and, in the covering position (AP), at least partially covers a rear window of the tailgate against damage caused by luggage (L) in the boot, includes: detecting a movement of the tailgate of the vehicle, moving the blind of the roller blind device in the direction of the retracted position (FP) into a protected position (SP) when the movement of the tailgate has been detected, and holding the blind of the roller blind device in the protected position (SP) during at least part of a subsequent movement of the tailgate.

According to certain aspects of the present disclosure, when the movement detected is an opening movement of the tailgate of the vehicle in the direction of an open position (OFP), the movement of the blind into the protected position (SP) occurs during the opening movement and/or after the opening movement of the tailgate into the open position (OFP).

According to certain aspects of the present disclosure, a detection of a starting position (ASP) of the blind in correlation to the covering position (AP), the retracted position (FP) and/or the protected position (SP), is registered.

According to certain aspects of the present disclosure, after completion of a closing movement of the tailgate, when the tailgate is in the closed position (SLP), the blind is automatically moved back to the starting position (ASP).

According to certain aspects of the present disclosure, when the movement detected is a closing movement of the tailgate of the vehicle in the direction of the closed position (SLP), the movement of the blind into the protected position (SP) occurs during the closing movement of the tailgate, wherein the duration of the movement of the blind into the protected position (SP) is less than the duration of the closing movement of the tailgate into the closed position (SLP).

According to certain aspects of the present disclosure, the protected position (SP) corresponds to or substantially corresponds to the retracted position (FP).

According to certain aspects of the present disclosure, a movement of the blind out of the protected position (SP) is blocked unless the tailgate is in the closed position (SLP).

According to certain aspects of the present disclosure, an operating signal (BS) for an operation of a display device is generated depending on the blind being in the covering position (AP).

According to certain aspects of the present disclosure, the operating signal (BS) continues to be generated with the blind outside of the covering position (AP) if at least one of the following specifications is met: the vehicle is stationary, the vehicle is switched off, and the tailgate is outside of the closed position (SLP).

According to certain aspects of the present disclosure, the roller blind device has an operating safety device which, if a movement of the blind in the direction of the covering position (AP) encounters resistance, disengages an active connection between the blind and the drive device, wherein the operating safety condition (BSZ) is detected.

According to certain aspects of the present disclosure, at least one of the following actions is performed on the basis of the detected operating safety condition (BSZ): blocking of the drive device, blocking of a movement of the tailgate, and blocking of an operating signal (BS).

According to certain aspects of the present disclosure, a computer program product includes commands which, when executed by a computer, cause it to carry out the steps of the protective method of any one of claims 1 to 11

According to certain aspects of the present disclosure, a protective device for carrying out a protective method for protecting a blind of a roller blind device for a rear blind on a tailgate of a vehicle, which can be moved by means of an electric drive device between a retracted position (FP) and a covering position (AP) and which, in the covering position (AP), at least partially covers a rear window of the tailgate against damage caused by luggage in the boot, includes: a detection module for detecting a movement of the tailgate of the vehicle; a movement module for moving the blind of the roller blind device in the direction of the retracted position (FP) into a protected position (SP) when the movement of the tailgate has been detected; and a holding module for holding the blind of the roller blind device in the protected position (SP) on a subsequent closing movement of the tailgate wherein the detection module, the movement module, and/or the holding module are designed to execute the protective method of any one of the claims 1 to 11.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 shows a vehicle in an exemplary unloaded situation, according to certain aspects of the present disclosure.

FIG. 2 shows the vehicle of FIG. 1 during loading, according to certain aspects of the present disclosure.

FIG. 3 shows the vehicle of FIGS. 1 and 2 after loading, with the tailgate in the closed position, according to certain aspects of the present disclosure.

FIG. 4 shows a step of an exemplary protective method, according to certain aspects of the present disclosure.

FIG. 5 shows another step of the exemplary protective method, according to certain aspects of the present disclosure.

FIG. 6 shows a further step of the exemplary protective method, according to certain aspects of the present disclosure.

FIG. 7 shows yet another step of the exemplary protective method, according to certain aspects of the present disclosure.

FIG. 8 shows a still further step of the exemplary protective method, according to certain aspects of the present disclosure.

FIG. 9 shows a step of a further embodiment of an exemplary protective method, according to certain aspects of the present disclosure.

FIG. 10 shows another step of the further embodiment of the exemplary protective method, according to certain aspects of the present disclosure.

FIG. 11 shows a further step of the further embodiment of the exemplary protective method, according to certain aspects of the present disclosure.

FIG. 12 shows a still further step of the further embodiment of the exemplary protective method, according to certain aspects of the present disclosure.

FIG. 13 shows yet another step of the further embodiment of the exemplary protective method, according to certain aspects of the present disclosure.

FIG. 14 shows an exemplary protective device, according to certain aspects of the present disclosure.

### DETAILED DESCRIPTION

Further features and details are disclosed in the dependent claims, the description, and the drawings. Naturally, features and details described in connection with the disclosed protective method also apply in connection with the disclosed computer program product as well as the disclosed protective device and vice versa, so that with regard to disclosure mutual reference is or can always be made to the individual aspects of the disclosure.

The core idea of the disclosure is based on avoiding, with a high degree of certainty, a geometrical conflict situation in which luggage in a boot of a vehicle could come into contact with a blind of a roller blind device in a covering position. This is difficult to predict when the tailgate is open and thus during a possible loading process. Therefore, the disclosed method moves the blind of the roller blind device into a protected position before and/or during the closing of the tailgate to the closed position. This protected position, which, as explained later, can in particular be identical to the retracted position, serves to substantially exclude a geometric contact due to collision between the blind and the luggage. If the protected position is the retracted position, this means that, before the start of the closing movement, or at least during the closing movement and before reaching the closed position of the tailgate, the blind has been moved to this protected position, for example in the form of the retracted position. In the situation involving bulky luggage described above, this ensures that when the tailgate reaches the closed position, the blind is no longer in the covering position, but in the protected position. In this protected position, it is now ensured that geometric contact with the luggage and the possible associated damage to the blind can be substantially excluded.

On this basis, it is now possible for this protected position to be assumed at different times. The decisive point is that the protected position is maintained and/or reached when the closing movement ends in the closed position. The triggering movement of the tailgate can be both the opening movement and the closing movement. The movement of the blind into the protected position can also take place during the opening movement, after reaching the open position and/or also during the closing movement. The decisive point is that the blind reaches the protected position and is held in this position when the last stretch of the closing movement into the closed position for the tailgate is performed.

According to the disclosure, this ensures that the blind is always in the protected position at the time the closed position is reached. This rules out a geometric conflict situation with any bulky luggage that may be present. This means that the protective function for the blind can be achieved without further sensors, especially without monitoring the boot. In particular, the protective method can even be applied to existing roller blind devices, and thus retrofitted, so to speak.

It can bring advantages if, in a protective method according to the disclosure, an opening movement of the tailgate of the vehicle in the direction of an open position is detected and the movement of the blind into the protected position occurs during the opening movement and/or after the opening movement of the tailgate into the open position. This procedure can also be understood as preparatory protection. If the tailgate is opened, i.e. moved from the closed position in the direction of the open position, this is to be understood in the sense of the present disclosure as an opening movement. Since an opening movement in a vehicle is usually followed shortly by a closing movement in the direction of the closed position, the protective mechanism of the present disclosure can also be triggered at the start of the opening movement.

In this embodiment, the trigger for assuming the protected position and thus performing the protective movement is therefore the opening movement of the tailgate. In other words, when the tailgate is opened, or during the opening of the tailgate, the movement of the blind into the protected position is started and the protected position is reached either during opening or after opening. It is also immaterial whether the movement into the protected position is already carried out during the performance of the opening movement of the tailgate or only starts after the open position has been reached. In both cases, the protected position is safely assumed even before the subsequent closing movement towards the closed position begins. In particular, if the tailgate is subsequently closed manually, either because there is no automatic closing device or manual closing is desired by the user, the security against the aforementioned damage mechanisms is further increased. In particular, geometric contact with the luggage by the blind can be excluded regardless of the closing speed, and thus also in the case of very fast closing movements of the tailgate, since this is already in the protected position, also before starting a manual and correspondingly fast closing movement.

Further advantages are also achieved if, in a protective method according to the disclosure, a detection of a starting position of the blind, in particular in correlation to the covering position, the retracted position and/or the protected position is registered. Before the start of the protective movement, and thus the movement from this starting position to the protected position, a detection of the actual state in the form of the starting position of the blind takes place. This starting position can be saved in order to carry out further method steps for example. The detection of this initial situation can also be triggered by the detection of the movement of the tailgate in order to be able, accordingly, to accurately detect this starting position at the same time before the start of the protective movement. Alternatively, continuous monitoring of the position of the blind is also conceivable, so that the starting position has already been registered at the time of the protective movement.

It is also advantageous if, in a protective method according to the disclosure according to the preceding paragraph, after completion of the closing movement of the tailgate, when this is again in the closed position, the blind is automatically moved back to the starting position. From the protected position and/or from the retracted position, an automatic reset movement takes place, so that after the closing movement of the tailgate has been completed, the blind can now be moved back to the starting position. If the blind was in a covering position before the tailgate was opened, the blind will also be moved back to the covering position as a starting position as soon as the tailgate is back in the closed position. Nor does this return movement any longer lead to a risk of damage, since in particular the operating safety device, which will be explained later, is provided in order to unclip the blind, and thus protect it, for example by unclipping a blind rod, when resistance is encountered during the extension movement. This known protective mechanism is now coupled with the protective mechanism according to the disclosure, so that the comfort function of the return movement to the starting position can be made available without impairing safety with regard to the protection functionality.

It also brings advantages if, in a protective method according to the disclosure, when the movement is detected, the closing movement of the tailgate of the vehicle in the direction of the closed position is detected and the movement of the blind into the protected position occurs during the closing movement, wherein the duration of the movement of the blind into the protected position is less than the duration of the closing movement of the tailgate into the closed position. In particular, this leads to the protected position being safely reached before the tailgate reaches the closed position. This further leads to the fact that the protective movement is only triggered by the closing movement and, accordingly, a correspondingly faster protective movement into the protected position must be guaranteed for the blind compared with the closing movement of the tailgate. In combination with the aforementioned reset movement into a starting position, this means that these protective movements remain substantially unnoticed by the user of the vehicle.

If the tailgate moves into the open position, the user of the vehicle can still see the blind in the covering position by looking up at the inner side of the tailgate. Only when the closing movement is started, in particular automatically, and during the closing movement, i.e. when the user moves back around the vehicle into the interior again, is the protective movement into the protected position carried out and the blind is then preferably guided back into the starting position after reaching the closed position. With a combination of these design variants, the user will not actively and consciously perceive the protective effect and will accordingly receive the aforementioned advantages without any restriction of comfort.

In addition, it brings further advantages if, in a protective method according to the disclosure, the protected position corresponds to or substantially corresponds to the retracted position. While, in principle, protected positions that are distanced from the retracted position, which preferably lie either between the covering position and the retracted position or, starting out from the covering position, lie on the other side and thus behind the retracted position, entail reduced complexity, since only substantially two precisely defined positions now have to be specified, other protected positions distanced from the retracted position are of course also conceivable in principle for higher or different protection requirements.

It also brings advantages if, in a protective method according to the disclosure, a movement of the blind out of the protected position is blocked until the tailgate is again in the closed position. A protective method according to the disclosure is carried out automatically without the intervention of the user. However, in the event of incorrect use, it may happen that the user or another passenger still in the vehicle passes on to the drive device of the roller blind device, as incorrect use, a movement request which conflicts with the protective concept according to the disclosure. If the protective method of the disclosure now blocks external control and thus blocks a movement of the blind, such incorrect uses can be blocked and, accordingly, the protective function can be further improved. In other words, movement instructions to the blind are not carried out during this block.

It also brings advantages if, in a protective method according to the disclosure, an operating signal for an operation of a display device is generated depending on the blind being in the covering position. The operating signal can also be understood as an enable signal which is needed to put the display device into operation in the vehicle. Such a display device is in particular a display device for the display of media content for the vehicle occupants in the rear seats of the vehicle. To ensure that other road users are not interfered with or distracted when the vehicle is being driven, the operating signal can only activate the display device when the blind is in a safe covering position. The operating signal is therefore also a safety signal.

In the case of the protective method according to the preceding paragraph, it brings further advantages if the operating signal continues to be generated with the blind outside of the covering position if at least one of the following requirements is met:

the vehicle is stationary

the vehicle is switched off

the tailgate is outside of the closed position.

The above list is a non-exhaustive list. In principle, fewer or more such specifications can also be combined with each other. The aim is to improve the use of the display device and in particular also to ensure this when there is no danger to road users, despite leaving the covering position. This can for example be the case if the vehicle is stationary, if the vehicle is in a parked situation and thus switched off, or if the tailgate is open. One or more such triggers can lead to the operating signal being generated even if there is actually an unsafe situation where the blind is outside of the covering position. In this way, the maximisation of the usability of the display device can be improved.

It also brings advantages if, in a protective method according to the disclosure, the roller blind device has an operating safety device which, if a movement of the blind in the direction of the covering position encounters resistance, disengages an active connection between the blind and the drive device, whereby the operating safety condition is detected. These can be solutions that separate a curtain rod from the drive device on the action of a mechanical resistance, for example on a curtain rod of the blind. For example, frictional connections, clip connections, or snap-in connections can be provided which disconnect on encountering sufficient resistance and release the blind from the corresponding drive carriage and thus lead to a loose blind. This unclipping in response to resistance can also be described as the assumption of the operating safety condition, which can be reversed by clipping the blind back in place manually. It is possible that additional sensors are provided here which, in particular on detecting the operating safety condition, prevents further use of the display device by preventing the generation of the operating signal.

It brings advantages if, in the protective method according to the preceding paragraph, at least one of the following actions is performed on the basis of the detected operating safety condition:

blocking of the drive device

blocking of a movement of the tailgate

blocking of an operating signal.

The above list is also a non-exhaustive list. Combinations are also conceivable in principle. It is desirable here that, when the operating safety condition is assumed, uncertainty can be excluded with this operating safety condition. This applies in particular with regard to undesirable damage to the blind in the unclipped state caused by moving the tailgate. However, an undesirable continued operation of the display device can also be prevented when the operating safety condition has been assumed.

The subject matter of the present disclosure also includes a computer program product comprising commands which, when executed by a computer, cause it to carry out the steps of a protective method according to the disclosure. Thus, a computer program product according to the disclosure also brings the same advantages as have been explained in detail with reference to a protective method according to the disclosure.

In addition, the subject matter of the present disclosure includes a protective device for carrying out a protective method for protecting a blind of a roller blind device for a rear roller blind on a tailgate of a vehicle. This roller blind device and thus the blind can be moved between a retracted position and a covering position by means of an electric drive device and at least partially covers a rear window of the tailgate in the covering position. The aim is to protect against damage caused by luggage in the boot. For this purpose, a detection module is provided for detecting a movement of the tailgate of the vehicle. Furthermore, a movement module is used to move the blind of the roller blind device in the direction of the retracted position into a protected position when the movement of the tailgate has been detected. With the help of a holding module, the blind of the roller blind device is held in the protected position on a subsequent closing movement of the tailgate into a closed position. The detection module, the movement module and/or the holding module are designed to carry out a protective method according to the disclosure. Thus, a protective device according to the disclosure brings the same advantages as have been explained in detail with reference to a protective method according to the disclosure.

Further advantages, features, and details of the disclosure are explained in the following description, in which exemplary embodiments of the disclosure are described in detail with reference to the drawings. In each case schematically:

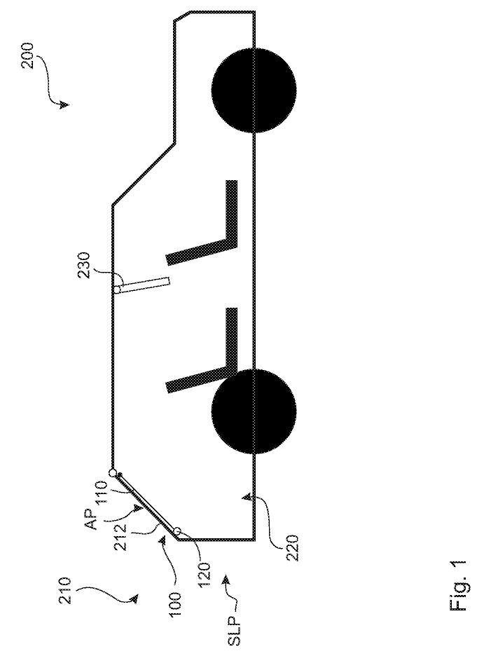

FIGS. 1 to 3 show the problem situation addressed by a protective method according to the disclosure. Here, a vehicle 200 is equipped with a boot 220. In the interior of the vehicle 200, a display device 230 is provided for the rear passengers. If the display device 230 is operated, a roller blind device 100 with a blind 110 in the covering position AP shown serves to prevent a view of the interior and thus of the display device 230.

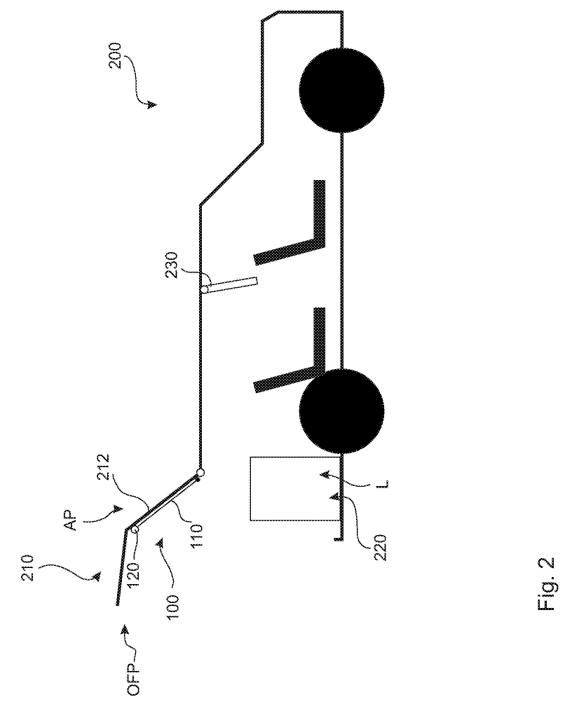

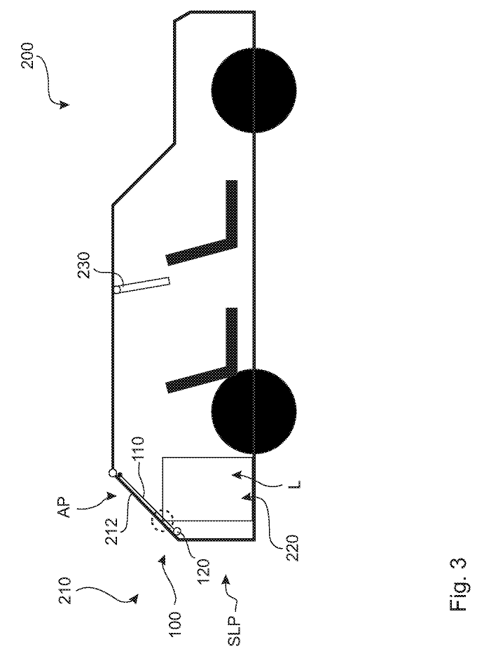

FIG. 2 now shows the loading situation in the embodiment of FIG. 1. The tailgate 210 of vehicle 200 was moved to the open position OFP. In this open position OFP, due to the lack of influence, the blind 110 is still in the covering position AP and thus covers the rear window 212. In the open position OFP, according to FIG. 2 a bulky item of luggage L has now been loaded into the boot 220. If the tailgate 210 is now moved back into the closed position SLP, a situation according to FIG. 3 results. Although the bulky luggage L fits into the boot 220, and it is also possible to close the tailgate 210 completely, a geometric conflict arises with the blind 110, as indicated by the dashed circle. In this case, the blind 110 can be directly damaged by the edge of the item of luggage L. In particular, if, in the state depicted in FIG. 3, a movement of the blind 110 from the covering position AP, driven by the drive device 120, is now to take place, this leads to very likely damage to the blind 110 due to the blind 110 rubbing along the edge of the luggage L. In the following explanation of the protective method, this situation is very reliably avoided.

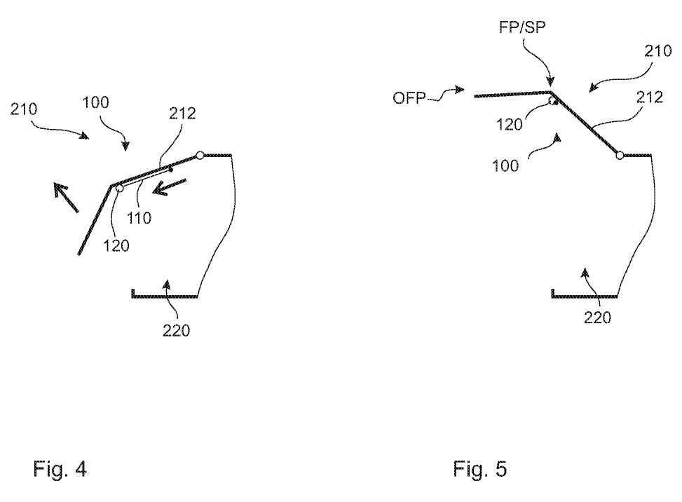

In FIG. 4, an opening process of the tailgate 210 starts and serves here as a trigger by detecting the opening movement as the movement of the tailgate 210 of the vehicle. A protective movement is started directly here, along the arrow direction shown, i.e. the blind 110 is wound up by the drive device 120 and moved in the direction of the retracted position FP as protected position SP. This has already been assumed in FIG. 5 and can be assumed before, during or after reaching the open position OFP shown in FIG. 5.

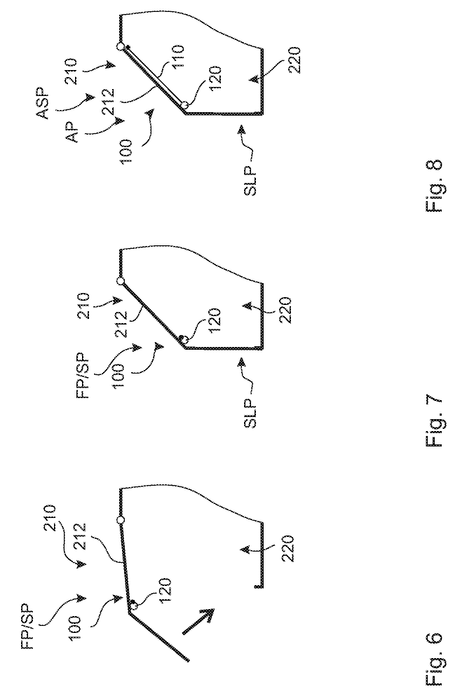

FIG. 6 now shows how, for example after the loading process has ended, as explained in FIGS. 1 to 3, the return movement to the closed position SLP according to FIG. 7 can take place again. During this closing movement, the retracted position FP is now maintained by the blind 110 as protected position SP and, accordingly, a situation according to FIG. 3 is reliably avoided.

FIG. 8 shows a further, supplementary variation of this protective method. For example, when starting the protective movement according to FIG. 4, it is possible to detect which starting position ASP the blind 110 had assumed. In FIG. 8, after reaching the closed position SLP, a reset movement to the starting position ASP, which in this case is the covering position AP, is carried out.

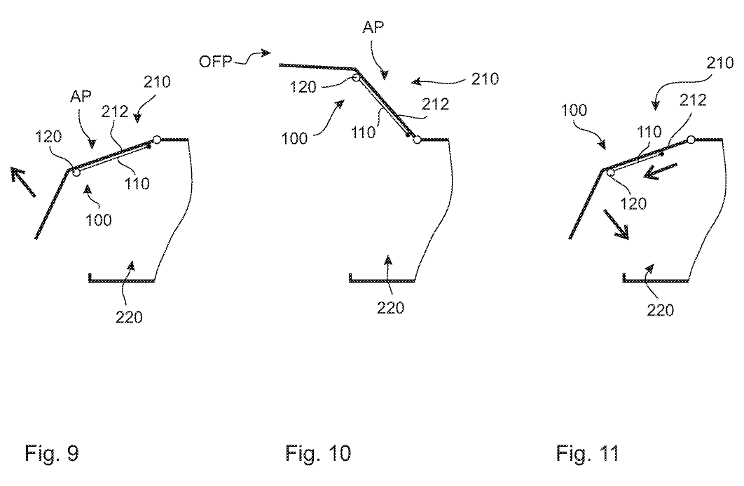

FIGS. 9 to 11 show a further embodiment of the method according to the disclosure.

Here, it is not the opening movement that triggers the protective movement, but the closing movement. In FIGS. 9 and 10, it can therefore be seen that when the tailgate 210 moves into the open position OFP, the blind 110 still remains in the covering position AP. Only when the closing movement is started, i.e. on or after leaving the open position OFP, does the protective movement start and thus the rolling-up of the blind 110 by the drive device 120 in the direction of the protected position SP. This is reached before the closed position SLP has been reached, so that the same protective effect has been achieved while avoiding the situation of FIG. 3.

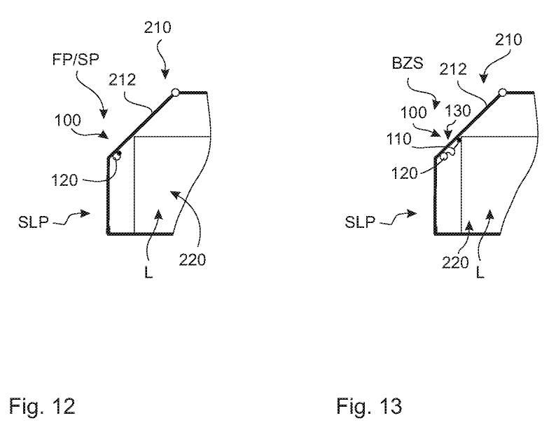

FIGS. 12 and 13 show an additional protection functionality of an operating safety device 130. As shown in FIG. 8, after reaching the closed position SLP, a manual or automated return movement to the covering position AP can now take place. If, in this situation, there is a bulky item of luggage L in the boot 220, this leads to resistance during the unwinding movement of the blind 110 and thus during the movement into the covering position AP. The operating safety device 130 can now for example ensure that the blind is unclipped from lateral guide carriages, so that a loose operating safety condition BSZ can be assumed by the blind 110, as shown in FIG. 13.

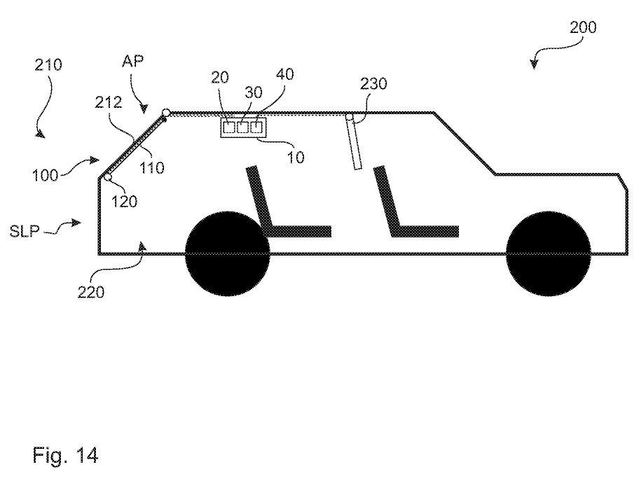

FIG. 14 shows schematically the implementation of a protective device 10. This is equipped here with a detection module 20, a movement module 30 and a holding module 40 in order to carry out the protective method according to the disclosure.

The above explanation of the embodiments describes the present disclosure exclusively in the context of examples.

### List of reference signs

10 protective device

20 detection module

30 movement module

40 holding module

100 roller blind device

110 blind

120 drive device

130 operating safety device

200 vehicle

210 tailgate

212 rear window

220 boot

230 display device

FP retracted position

AP covering position

SP protected position

ASP starting position

SLP closed position

OFP open position

BS operating signal

BSZ operating safety condition

L luggage

What is claimed is:

1. A protective method for protecting a blind of a roller blind device for a rear roller blind on a tailgate of a vehicle which can be moved by means of an electric drive device between a retracted position (FP) and a covering position (AP) and, in the covering position (AP), at least partially covers a rear window of the tailgate against damage caused by luggage (L) in the boot, the method comprising:
detecting a movement of the tailgate of the vehicle,
moving the blind of the roller blind device in the direction of the retracted position (FP) into a protected position (SP) when the movement of the tailgate has been detected, and
holding the blind of the roller blind device in the protected position (SP) during at least part of a subsequent movement of the tailgate.

2. The protective method according to claim 1, wherein when the movement detected is an opening movement of the tailgate of the vehicle in the direction of an open position (OFP), the movement of the blind into the protected position (SP) occurs during the opening movement and/or after the opening movement of the tailgate into the open position (OFP).

3. The protective method according to claim 2, wherein a detection of a starting position (ASP) of the blind in correlation to the covering position (AP), the retracted position (FP), and/or the protected position (SP), is registered.

4. The protective method according to claim 3, wherein after completion of a closing movement of the tailgate, when the tailgate is in the closed position (SLP), the blind is automatically moved back to the starting position (ASP).

5. The protective method according to claim 1, wherein when the movement detected is a closing movement of the tailgate of the vehicle in the direction of the closed position (SLP), the movement of the blind into the protected position (SP) occurs during the closing movement of the tailgate, wherein the duration of the movement of the blind into the protected position (SP) is less than the duration of the closing movement of the tailgate into the closed position (SLP).

6. The protective method according to claim 1, wherein the protected position (SP) corresponds to or substantially corresponds to the retracted position (FP).

7. The protective method according to claim 1, wherein a movement of the blind out of the protected position (SP) is blocked unless the tailgate is in the closed position (SLP).

8. The protective method according to claim 1, wherein an operating signal (BS) for an operation of a display device is generated depending on the blind being in the covering position (AP).

9. The protective method according to claim 8, wherein the operating signal (BS) continues to be generated with the blind outside of the covering position (AP) if at least one of the following specifications is met:
the vehicle is stationary,
the vehicle is switched off, and
the tailgate is outside of the closed position (SLP).

10. The protective method according to claim 1, wherein the roller blind device has an operating safety device which, if a movement of the blind in the direction of the covering position (AP) encounters resistance, disengages an active connection between the blind and the drive device, wherein the operating safety condition (BSZ) is detected.

11. The protective method according to claim 10, wherein at least one of the following actions is performed on the basis of the detected operating safety condition (BSZ):
blocking of the drive device,
blocking of a movement of the tailgate, and
blocking of an operating signal (BS).

12. A computer program product comprising commands which, when executed by a computer, cause it to carry out the steps of the protective method of claim 1.

13. A protective device for carrying out a protective method for protecting a blind of a roller blind device for a rear blind on a tailgate of a vehicle, which can be moved by means of an electric drive device between a retracted position (FP) and a covering position (AP) and which, in the covering position (AP), at least partially covers a rear window of the tailgate against damage caused by luggage in the boot, the protection device comprising:
a detection module for detecting a movement of the tailgate of the vehicle;
a movement module for moving the blind of the roller blind device in the direction of the retracted position (FP) into a protected position (SP) when the movement of the tailgate has been detected; and
a holding module for holding the blind of the roller blind device in the protected position (SP) on a subsequent closing movement of the tailgate wherein the detection module, the movement module, and/or the holding module are designed to execute the protective method of claim 1.
